(19) United States
(12) Patent Application Publication
(10) Pub. No.: US 2019/0329639 A1
(43) Pub. Date: Oct. 31, 2019

(54) GLASS RUN

(71) Applicant: TOYODA GOSEI CO., LTD., Kiyosu-shi (JP)

(72) Inventor: Hiroshi SUGAWA, Kiyosu-shi (JP)

(21) Appl. No.: 16/390,141

(22) Filed: Apr. 22, 2019

(30) Foreign Application Priority Data
Apr. 27, 2018 (JP) 2018-086104

(51) Int. Cl. B60J 10/235; B60J 10/76; B60J 10/26; B60J 10/33

(52) U.S. Cl. CPC B60J 10/235; B60J 10/33; B60J 10/26; B60J 10/76

(57) ABSTRACT

A glass run is adapted to seal a space between a door frame and a door glass. A vehicle interior hinge portion is formed at a connection portion between a vehicle interior side wall and a glass run portion bottom wall of a glass run portion, and the vehicle interior side wall is formed to be pivotable around the vehicle interior hinge portion. A vehicle interior side wall retaining lip extending from a vehicle inside to a vehicle outside and in an inner peripheral direction and abutting against a door panel inner peripheral side flange portion of the door frame is formed at a tip of the vehicle interior side wall, and the vehicle interior side wall retaining lip is formed so that a biasing force on the door panel inner peripheral side flange portion increases when the vehicle interior side wall is pivoted toward the vehicle outside.

### CROSS-REFERENCE TO RELATED APPLICATIONS

This application is based upon and claims the benefit of priority from prior Japanese patent application No. 2018-086104, filed on Apr. 27, 2018, the entire contents of which are incorporated herein by reference.

### TECHNICAL FIELD

The present invention relates to a glass run which is attached to a door frame and adapted to seal a space between a peripheral edge of a vehicle body opening and a door.

### BACKGROUND ART

In a vehicle sealing structure for sealing a space between a peripheral edge of a vehicle body opening and a door having a door frame, for example, an opening trim weather strip is attached to a flange of an opening edge of a vehicle body door, and a door weather strip is attached to an outer periphery of the door frame. When the door is closed, a hollow sealing portion of the opening trim weather strip is abutted against a bulging portion of the door frame, and a hollow sealing portion and a seal lip of the door weather strip are abutted against an outer panel of the peripheral edge of the vehicle body opening, thereby sealing the space between the peripheral edge of the vehicle body opening and the door.

At this time, a door glass raised and lowered inside the door is held by a glass run whose periphery is attached to an inner peripheral side of the door frame. The door glass is raised and lowered in a groove portion of the glass run having a substantially U-shaped cross-section, and the sealing between the door glass and the door frame is performed by the glass run.

In the appearance of the side of the vehicle, the glass run and the door frame become conspicuous around the door glass, and there is a need for improvement in terms of design. Further, since the glass run is provided between the door frame and the door glass, a gap is present on the surface between the door frame and the door glass, which is not desirable from the viewpoint of design.

Therefore, as shown in FIG. 4, in a vehicle body of a hidden door type vehicle, an exterior surface of a door frame of a roof part is removed except for a flange, and only a glass run is provided in the roof part, thereby improving the design.

In this case, as shown in FIG. 5, a glass run 110 includes a glass run portion 120 for sealing a space between a door glass 5 and a door frame 2, and a trim portion 130 for attaching the glass run 110 to a door frame flange portion 2g at the tip of the door frame 2 (e.g., see JP-A-2012-106715). The glass run portion 120 includes a main body having a substantially U-shaped cross-section formed by a vehicle exterior side wall 121, a vehicle interior side wall 122 and a bottom wall 123, and a vehicle exterior seal lip 124 and a vehicle interior seal lip 125 respectively extending obliquely toward the inside of the substantially U-shaped cross-section from the tips of the vehicle exterior side wall 121 and the vehicle interior side wall 122. Further, the door glass 5 is sealed by the vehicle exterior seal lip 124 and the vehicle interior seal lip 125.

The trim portion 130 has a substantially U-shaped cross-section which is formed by a glass run-side side wall 131 formed integrally with the bottom wall 123 of the glass run portion 120, a body-side side wall 132, and a trim portion bottom wall 133. Trim portion seal lips 134, 135 are formed on the outer surface of the body-side side wall 132 so as to abut against and seal a peripheral edge 6 of a vehicle body opening when the door is closed.

In this case, a reinforcing lip 126 is provided on the vehicle interior side of the vehicle interior side wall 122, and a door frame engagement portion 2f is provided so as to lock the reinforcing lip 126 on the door frame 2. However, it takes time and effort to form the door frame engagement portion 2f by bending the sheet metal of the door frame 2, and it also takes time and effort to assemble the glass run 110. Further, it is difficult to process the aluminum door frame 2.

Therefore, an object of the invention is to provide a glass run which makes it easy to process a door frame, which can be easily assembled, and which can be prevented from being released from the door frame.

### SUMMARY OF INVENTION

According to an aspect of the invention, there is provided a glass run attached to a door frame and adapted to seal a space between the door frame and a door glass, wherein the door frame includes a door panel outer peripheral side flange portion and a door panel inner peripheral side flange portion which are formed at a tip of the door frame and to which the glass run is attached, the glass run includes a trim portion attached to the door panel outer peripheral side flange portion, and a glass run portion formed integrally with the trim portion and attached to the door panel inner peripheral side flange portion, the glass run portion configured to seal a space between the door glass and the door panel inner peripheral side flange portion, the glass run portion has a substantially U-shaped cross-section formed by a vehicle exterior side wall, a vehicle interior side wall and a glass run portion bottom wall, and a vehicle exterior seal lip and a vehicle interior seal lip respectively extend obliquely toward an inside of the substantially U-shaped cross-section from tips of the vehicle exterior side wall and the vehicle interior side wall, the trim portion has a substantially U-shaped cross-section formed by a glass run-side side wall, a body-side side wall and a trim portion bottom wall, and the glass run-side side wall and the glass run portion bottom wall of the glass run portion are integrally formed or are formed as a same member, a vehicle interior hinge portion is formed at a connection portion between the vehicle interior side wall and the glass run portion bottom wall, and the vehicle interior side wall is formed to be pivotable around the vehicle interior hinge portion, and a vehicle interior side wall retaining lip extending from a vehicle inside to a vehicle outside and in an inner peripheral direction and abutting against the door panel inner peripheral side flange portion is formed at a tip of the vehicle interior side wall, and the vehicle interior side wall retaining lip is formed so that a biasing force on the door panel inner peripheral side flange portion increases when the vehicle interior side wall is pivoted toward the vehicle outside.

### BRIEF DESCRIPTION OF DRAWINGS

FIG. 1 is a sectional view of a glass run in an embodiment of the invention, taken along the line A-A in FIG. 3;

FIG. 2 is an enlarged sectional view of a portion of a vehicle interior side wall retaining lip of a vehicle interior side wall of the glass run in the embodiment of the invention;

FIG. 3 is a front view of the glass run in the embodiment of the invention;

FIG. 4 is a side view of a vehicle; and

FIG. 5 is a sectional view of a related-art glass run.

### DESCRIPTION OF EMBODIMENTS

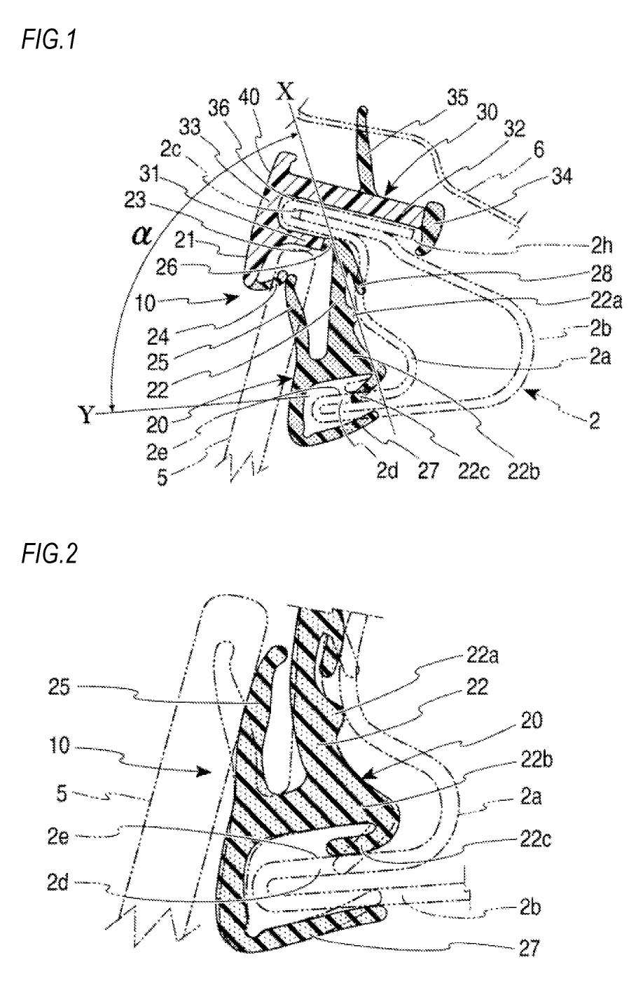

An embodiment of the invention will be described with reference to FIGS. 1 to 4.

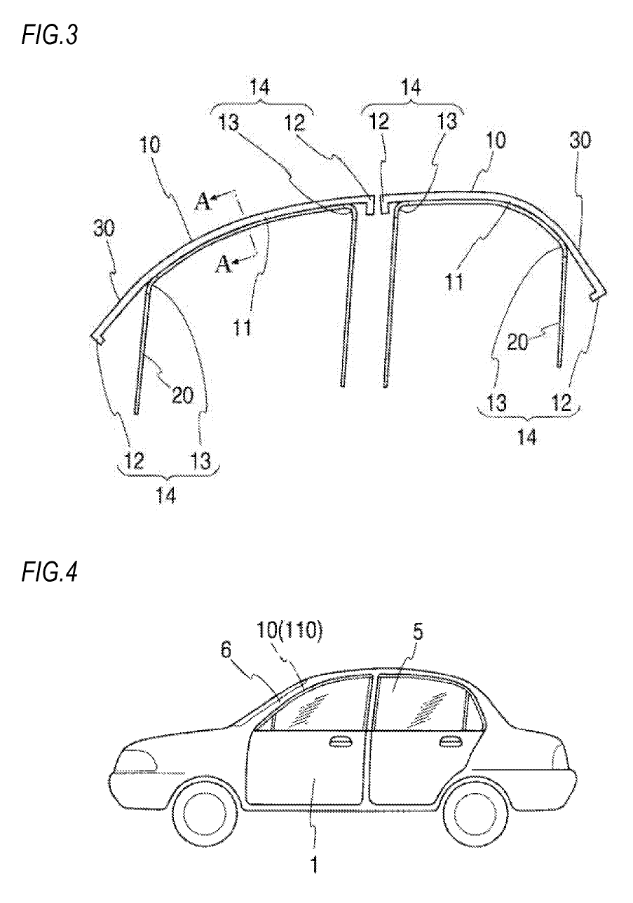

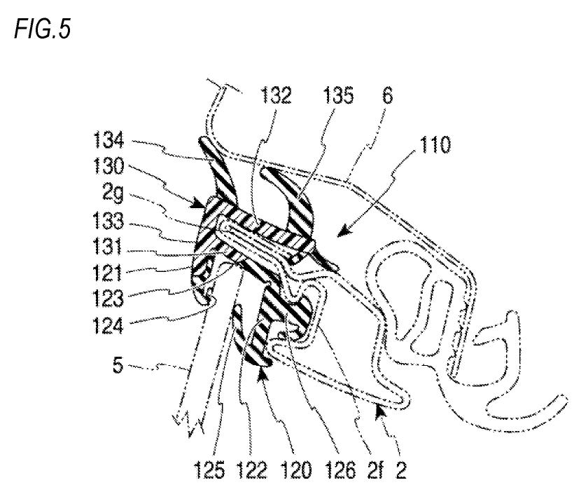

FIGS. 1 and 2 show an embodiment of the invention. FIG. 3 is a front view showing the shape of a glass run 10 of the present embodiment in a state where the glass run 10 is attached to a door frame 2 of a door 1.

FIG. 4 is a side view of a vehicle. On the upper portion of the door 1, the door frame 2 is provided at a portion opposed to a peripheral edge 6 of a vehicle body opening, and a door glass 5 is attached to the door frame 2 so as to be movable up and down. That is, the glass run 10 is attached to the inner periphery of the door frame 2 to guide the raising and lowering of the door glass 5 and to seal a space between the door glass 5 and the door frame 2.

The embodiment of the invention will be described with reference to FIGS. 1 and 2.

As shown in FIG. 1, the door frame 2 to which the glass run 10 is attached has a door panel outer peripheral side flange portion 2c at the tip on the outer peripheral side of the door frame 2, and a door panel inner peripheral side flange portion 2d at the tip on the inner peripheral side of the door frame 2. The door panel inner peripheral side flange portion 2d is formed by bending a door outer panel 2a into a hairpin shape, and the door panel outer peripheral side flange portion 2c is formed by sandwiching a tip portion of a door inner panel 2b inside the tip portion formed into the hairpin shape.

The door panel outer peripheral side flange portion 2c holds a trim portion 30 of the glass run 10, and the door panel inner peripheral side flange portion 2d holds a glass run portion 20 of the glass run 10.

Meanwhile, the glass run portions 20 attached to vertical side portions of the door frame 2 are coupled to the lower side of corner portions 13 on the front side and the rear side of the glass run 10. Therefore, not only the upper side of the door frame 2 but also the portion of the vertical side on the side end of the door glass 5 can be held and sealed by the glass run portion 20. The glass run portion 20 attached to a connection portion between the upper side and the vertical side of the door frame 2 configures the corner portions 13, and is formed by connecting the corner portions 13 of the upper and vertical side portions of the glass run portion 20 using a molding work.

As shown in FIG. 1, the glass run 10 attached to the upper side of the door frame 2 has the glass run portion 20 attached to the door panel inner peripheral side flange portion 2d of the door frame 2 and the trim portion 30 attached to the door panel outer peripheral side flange portion 2c of the door frame 2. First, the entire shape of the glass run 10 will be described separately for the glass run portion 20 and the trim portion 30.

The glass run portion 20 includes a main body having a substantially U-shaped cross-section formed by a vehicle exterior side wall 21, a vehicle interior side wall 22 and a glass run portion bottom wall 23, and a vehicle exterior seal lip 24 and a vehicle interior seal lip 25 respectively extending obliquely toward the inside of the substantially U-shaped cross-section from the tips of the vehicle exterior side wall 21 and the vehicle interior side wall 22. Therefore, an end portion of the door glass 5 slides inside the substantially U-shaped cross-section formed by the vehicle exterior side wall 21, the vehicle interior side wall 22 and the glass run portion bottom wall 23, so that the door glass 5 can be held.

The vehicle interior side wall 22, the vehicle exterior seal lip 24 and the vehicle interior seal lip 25 of the glass run portion 20 are formed of a soft member. As the soft member, it is preferable to use an olefin-based thermoplastic elastomer. Since the soft member is used, the vehicle exterior seal lip 24 and the vehicle interior seal lip 25 can be flexibly bent. When the door glass 5 is raised, the vehicle exterior seal lip 24 and the vehicle interior seal lip 25 can reliably abut against the end portion of the door glass 5, thereby sealing a space between the door glass 5 and the door frame 2.

When the olefin-based thermoplastic elastomer is used as the soft member and the trim portion 30 uses an olefin-based synthetic resin as a hard member which is harder than the soft member, both of them can be easily welded and easily recycled. Meanwhile, foams may be used.

The vehicle exterior side wall 21 and the glass run portion bottom wall 23 are formed of a hard member, which is harder than the soft member, to be described later.

The vehicle exterior side wall 21 is formed in such a manner that its wall thickness is thick at a root portion and is made thinner toward the tip. Therefore, the inner surface of the vehicle exterior side wall 21 is curved. In this way, even when the rigidity of the vehicle exterior side wall 21 is large and the curvature of the door frame 2 is large, it is possible to reduce deformation such as creasing or waving of the vehicle exterior side wall 21. Further, even when the door glass 5 is shifted to the vehicle outside, the tip of the door glass 5 can be held by the vehicle exterior side wall 21, and the door glass 5 does not come off from the glass run portion 20.

A layer of a hard member is formed on a vehicle exterior sliding surface and a vehicle interior sliding surface of the vehicle exterior seal lip 24 and the vehicle interior seal lip 25 abutting against the door glass 5. Since the vehicle exterior sliding surface and the vehicle interior sliding surface are made of a hard member, the sliding friction with the door glass 5 is low, and a low sliding layer is formed. In this way, the door glass 5 can be smoothly raised and lowered, and the occurrence of abnormal noised can be prevented.

A bottom wall lip can be formed on the inner surface side of the glass run portion bottom wall 23. The bottom wall lip can be formed of a soft material similar to those of the vehicle exterior seal lip 24 and the vehicle interior seal lip 25. When the door glass 5 is raised, an upper end of the door glass 5 abuts against the bottom wall lip, and the bottom wall lip can absorb the impact on the glass run portion bottom wall 23. Preferably, a low sliding member is also applied on the surface of the bottom wall lip.

A thin-walled vehicle interior hinge portion 26 is formed at a connection portion between the vehicle interior side wall 22 and the glass run portion bottom wall 23. When attaching the glass run portion 20, the vehicle interior side wall 22 is formed to be rotatable about the vehicle interior hinge portion 26. Therefore, when the glass run 10 is attached to the door frame 2, the trim portion 30 is attached to the door panel outer peripheral side flange portion 2c, and then, the vehicle interior side wall 22 is pivoted. In this manner, the glass run portion 20 can be easily attached to the door panel inner peripheral side flange portion 2d.

The vehicle interior hinge portion 26 is a pivot center when the vehicle interior side wall 22 is pivoted.

The vehicle interior hinge portion 26 is formed in such a manner that an angle α (indicated by a in FIG. 1) at which a straight line X (indicated by X in FIG. 1) connecting a root portion of a vehicle interior side wall retaining lip 22c and the pivot center which is the vehicle interior hinge portion 26 intersects with a door panel inner peripheral side flange abutting surface 2e (a line indicated by Y in FIG. 1 is an extending line from the door panel inner peripheral side flange abutting surface 2e) becomes an acute angle.

With such a configuration, when the glass run portion 20 is pulled toward the vehicle outside due to an external force acting on the vehicle interior side wall 22 of the glass run portion 20 and is moved in a direction away from the door panel inner peripheral side flange portion 2d, the root portion of the vehicle interior side wall retaining lip 22c (to be described later) approaches the door panel inner peripheral side flange abutting surface 2e by the pivotal locus thereof, and the vehicle interior side wall retaining lip 22c can increase its biasing force and prevent the detachment of the glass run portion 20.

As shown in FIGS. 1 and 2, the vehicle interior side wall retaining lip 22c extending from the vehicle inside to the vehicle outside and in an inner peripheral direction (diagonally leftward and downward in FIG. 1) and abutting against the door panel inner peripheral side flange portion 2d is formed at the tip of the vehicle interior side wall 22. The vehicle interior side wall retaining lip 22c is formed so that the biasing force thereof on the door panel inner peripheral side flange portion 2d increases when the vehicle interior side wall 22 is pivoted toward the vehicle outside. The vehicle interior side wall retaining lip 22c is formed of a soft material similar to that of the vehicle interior side wall 22.

Further, the vehicle interior side wall retaining lip 22c is formed to be inclined from the vehicle inside to the vehicle outside and in the inner peripheral direction. Therefore, in order for the vehicle interior side wall 22 to move toward the vehicle outside and to be detached from the door panel inner peripheral side flange portion 2d, it is necessary to invert the vehicle interior side wall retaining lip 22c. In the present embodiment, a gap between the tip surface of the vehicle interior side wall 22 and the door panel inner peripheral side flange abutting surface 2e is made to be equal to or less than twice the thickness of the vehicle interior side wall retaining lip 22c. Therefore, the inversion of the vehicle interior side wall retaining lip 22c is suppressed, which contributes to preventing the detachment of the glass run portion 20.

When the angle α formed by the above-described straight line X and the door panel inner peripheral side flange abutting surface 2e is made to an acute angle, the vehicle interior side wall retaining lip 22c can increase its biasing force on the door panel inner peripheral side flange abutting surface 2e when the vehicle interior side wall 22 is pivoted around the vehicle interior hinge portion 26. Therefore, the vehicle interior side wall 22 does not necessarily intersect with the door panel inner peripheral side flange abutting surface 2e at an acute angle, but may intersect therewith at an obtuse angle in some cases. Further, forming the vehicle interior hinge portion 26 on the vehicle outside than the vehicle interior side wall 22 is preferable because the above-described action and effect become more remarkable.

When the glass run portion 20 is attached to the door panel inner peripheral side flange portion 2d, the vehicle interior side wall retaining lip 22c abuts against the door panel inner peripheral side flange abutting surface 2e. At this time, since the vehicle interior side wall retaining lip 22c is formed obliquely with respect to the insertion direction, the vehicle interior side wall retaining lip 22c can be pushed and bent by the door panel inner peripheral side flange portion 2d and can be slid along the door panel inner peripheral side flange abutting surface 2e. In this manner, the glass run portion 20 can be easily attached to the door panel inner peripheral side flange portion 2d with less friction.

Preferably, a vehicle interior side wall protuberance 22b bulging toward the vehicle inside is formed at the tip of the vehicle interior side wall 22, and the vehicle interior side wall retaining lip 22c is formed from the tip of the vehicle interior side wall protuberance 22b. In this case, the angle α at which the straight line X intersects with the door panel inner peripheral side flange abutting surface 2e can be made to a more acute angle. When the vehicle interior side wall 22 is pivoted, the above-described action and effect become remarkable and the vehicle interior side wall retaining lip 22c can increase its biasing force to prevent the detachment of the glass run portion 20.

Meanwhile, when the vehicle interior side wall 22 is pivoted, the vehicle interior side wall protuberance 22b must be able to maintain a gap between the door panel inner peripheral side flange abutting surface 2e and the vehicle interior side wall 22 against the biasing force of the vehicle interior side wall retaining lip 22c. Therefore, it is preferable that the vehicle interior side wall protuberance 22b is formed in a triangular shape or a trapezoidal shape widening from the tip on the vehicle inside toward the vehicle interior side wall 22. By adopting such a shape, the gap is maintained against the biasing force of the vehicle interior side wall retaining lip 22c formed at the tip of the vehicle interior side wall protuberance 22b. In this way, the inversion of the vehicle interior side wall retaining lip 22c is prevented and the detachment of the glass run portion 20 can be more reliably prevented.

Further, it is preferable that the gap between an inner peripheral side surface of the vehicle interior side wall protuberance 22b and the door panel inner peripheral side flange abutting surface 2e is formed to be substantially the same as the gap between the vehicle interior side wall 22 and the door panel inner peripheral side flange abutting surface 2e.

Preferably, a vehicle interior side wall ridge 22a protruding to the vehicle inside is formed at an intermediate portion on the vehicle inner side of the vehicle interior side wall 22. In this case, when the glass run portion 20 of the glass run 10 is attached to the door panel inner peripheral side flange portion 2d, the vehicle interior side wall ridge 22a abuts against an intermediate point of the door panel outer peripheral side flange portion 2c and the door panel inner peripheral side flange portion 2d of the door frame 2. In this way, it is possible to form a gap between the vehicle interior side wall protuberance 22b or the vehicle interior side wall 22 and the door frame 2.

Therefore, when the glass run portion 20 of the glass run 10 is attached to the door panel inner peripheral side flange portion 2d, the glass run portion 20 can be further inserted to the vehicle inside by a gap between the vehicle interior side wall protuberance 22b and the door frame 2. The vehicle interior side wall retaining lip 22c can be reliably assembled and prevented from being detached from the door panel inner peripheral side flange portion 2d.

A vehicle interior holding lip 28 can be formed in the vicinity of a connection portion with the glass run portion bottom wall 23 on the vehicle inner side of the vehicle interior side wall 22. The vehicle interior holding lip 28 can improve the sealing property between the door frame 2 and the vehicle interior side wall 22 and urge the trim portion 30 toward the vehicle outside, so that the trim portion 30 can be reliably locked.

A vehicle interior cover lip 27 can be provided at the tip of the outer surface of the vehicle interior side wall 22.

The tip of the door panel inner peripheral side flange portion 2d is inserted between the vehicle interior cover lip 27 and the vehicle interior side wall retaining lip 22c. The vehicle interior cover lip 27 covers and abuts against the tip of the door panel inner peripheral side flange portion 2d.

The vehicle exterior seal lip 24, the vehicle interior seal lip 25, the vehicle interior side wall retaining lip 22c, the vehicle interior cover lip 27, and the vehicle interior holding lip 28 are formed of a soft member. Therefore, the tip portion of the door glass 5 can be sealed by the vehicle exterior seal lip 24 and the vehicle interior seal lip 25. Further, since the vehicle interior side wall 22 is flexibly bent, the vehicle interior side wall 22 can be easily attached even when the door frame 2 is curved.

Subsequently, the trim portion 30 will be described. The trim portion 30 has a substantially U-shaped cross-section formed by a glass run-side side wall 31 formed integrally with the glass run portion bottom wall 23, a body-side side wall 32 opposed to the peripheral edge 6 of the vehicle body opening, and a trim portion bottom wall 33.

The door panel outer peripheral side flange portion 2c of the door frame 2 is inserted into a trim portion flange recess 36 that is the inside of the substantially U-shaped cross-section and clamped by the trim portion 30, so that the glass run 10 is held on the door frame 2.

In the present embodiment, the glass run portion bottom wall 23 of the glass run portion 20 and the glass run-side side wall 31 of the trim portion 30 are integrally formed as the same member with the same material as the hard member. However, the glass run portion bottom wall 23 and the glass run-side side wall 31 may be integrally formed by fusing both together using different materials.

A trim portion holder 34 is formed at the tip of the body-side side wall 32. As shown in FIG. 1, when the door panel outer peripheral side flange portion 2c is inserted into the trim portion flange recess 36, the trim portion holder 34 abuts against a door outer panel flange tip portion 2h formed at the tip of the door outer panel 2a of the door panel outer peripheral side flange portion 2c and the trim portion 30 is held on the door panel outer peripheral side flange portion 2c.

The trim portion holder 34 is formed of a soft material and is formed continuously in a longitudinal direction. Therefore, the trim portion holder 34 is easily assembled and reliably abuts against the door outer panel flange tip portion 2h of the door panel outer peripheral side flange portion 2c.

In the trim portion 30, the glass run-side side wall 31, the body-side side wall 32 and the trim portion bottom wall 33 are formed of a hard member. The trim portion holder 34 is formed of a soft member. The entire glass run portion 20 and the entire trim portion 30 are extrusion-molded by simultaneous molding of a hard member and a soft member. Meanwhile, the vehicle exterior side wall 21 of the glass run portion 20 is formed of a hard member as described above.

In this way, the main body portion of the trim portion 30 has high rigidity and can hold the door panel outer peripheral side flange portion 2c. The trim portion holder 34 can compliantly abut against and seal the door panel outer peripheral side flange portion 2c according to the shape of the peripheral edge 6 of the vehicle body opening.

As shown in FIGS. 1 and 2, the vehicle exterior side wall 21 of the glass run portion 20 and the trim portion bottom wall 33 of the trim portion 30 are integrally and continuously formed, and the vehicle outside surface is formed in a smooth circular arc shape. A vehicle exterior decorative member 40 can be attached to continuously cover the vehicle outside surface from the upper ends of the vehicle exterior side wall 21 and the trim portion bottom wall 33 to the lower end of the vehicle exterior side wall 21.

Therefore, the vehicle outside surface of the glass run 10 is formed by the vehicle exterior side wall 21 of the glass run portion 20 and the trim portion bottom wall 33 of the trim portion 30. In this way, the door glass 5 is held so as not to be pulled out to the vehicle outside and the appearance of the vehicle outside surface of the glass run 10 can be improved by the vehicle outside decorative member 40.

When the vehicle outside decorative member 40 is formed of an olefin-based synthetic resin material, the bonding property with a vehicle outside lower reinforcing member 52 is good and the reinforcing effect can be improved.

As the vehicle outside decorative member, a decorative tape having metallic luster can be used. When the decorative tape having metallic luster is used as the vehicle outside decorative member, the vehicle outside surface of the glass run 10 can be made to have a metallic luster color by the vehicle outside decorative member, thereby improving the appearance.

According to an aspect of the invention, there is provided a glass run attached to a door frame and adapted to seal a space between the door frame and a door glass, wherein the door frame includes a door panel outer peripheral side flange portion and a door panel inner peripheral side flange portion which are formed at a tip of the door frame and to which the glass run is attached, the glass run includes a trim portion attached to the door panel outer peripheral side flange portion, and a glass run portion formed integrally with the trim portion and attached to the door panel inner peripheral side flange portion, the glass run portion configured to seal a space between the door glass and the door panel inner peripheral side flange portion, the glass run portion has a substantially U-shaped cross-section formed by a vehicle exterior side wall, a vehicle interior side wall and a glass run portion bottom wall, and a vehicle exterior seal lip and a vehicle interior seal lip respectively extend obliquely toward an inside of the substantially U-shaped cross-section from tips of the vehicle exterior side wall and the vehicle interior side wall, the trim portion has a substantially U-shaped cross-section formed by a glass run-side side wall, a body-side side wall and a trim portion bottom wall, and the glass run-side side wall and the glass run portion bottom wall of the glass run portion are integrally formed or are formed as a same member, a vehicle interior hinge portion is formed at a connection portion between the vehicle interior side wall and the glass run portion bottom wall, and the vehicle interior side wall is formed to be pivotable around the vehicle interior hinge portion, and a vehicle interior side wall retaining lip extending from a vehicle inside to a vehicle outside and in an inner peripheral direction and abutting against the door panel inner peripheral side flange portion is formed at a tip of the vehicle interior side wall, and the vehicle interior side wall retaining lip is formed so that a biasing force on the door panel inner peripheral side flange portion increases when the vehicle interior side wall is pivoted toward the vehicle outside.

In the above aspect of the invention, the glass run is attached to the door frame and adapted to seal the space between the door frame and the door glass. The door frame includes the door panel outer peripheral side flange portion and the door panel inner peripheral side flange portion which are formed at the tip of the door frame and to which the glass run is attached. Therefore, the trim portion of the glass run can be held by the door panel outer peripheral side flange portion, and the glass run portion of the glass run can be held by the door panel inner peripheral side flange portion.

The glass run includes the trim portion attached to the door panel outer peripheral side flange portion, and the glass run portion formed integrally with the trim portion, attached to the door panel inner peripheral side flange portion, and configured to seal the space between the door glass and the door panel inner peripheral side flange portion. Therefore, it is not necessary to form a channel in order to hold the glass run portion in the door frame. When the trim portion is attached to the door panel outer peripheral side flange portion, the trim portion is firmly held by the door panel outer peripheral side flange portion, the glass run can be attached to the door frame, and the attachment of the glass run is easy.

The glass run portion has the substantially U-shaped cross-section formed by the vehicle exterior side wall, the vehicle interior side wall and the glass run portion bottom wall, and the vehicle exterior seal lip and the vehicle interior seal lip respectively extend obliquely toward the inside of the substantially U-shaped cross-section from the tips of the vehicle exterior side wall and the vehicle interior side wall. Therefore, an end portion of the door glass slides inside the substantially U-shaped cross-section formed by the vehicle exterior side wall, the vehicle interior side wall and the glass run portion bottom wall, so that the door glass can be held. Further, the vehicle exterior seal lip and the vehicle interior seal lip abut against the end portion of the door glass, so that the space between the door glass and the door frame can be sealed.

The trim portion has the substantially U-shaped cross-section formed by the glass run-side side wall, the body-side side wall and the trim portion bottom wall, and the glass run-side side wall and the glass run portion bottom wall of the glass run portion are integrally formed or are formed as the same member. Therefore, it is not necessary to form a channel in order to hold the glass run portion in the door frame. When the trim portion is attached to the door panel outer peripheral side flange portion, the trim portion is firmly held by the door panel outer peripheral side flange portion, the glass run can be attached to the door frame, and the attachment of the glass run is easy. Further, the door panel outer peripheral side flange portion at the tip of the door frame can be clamped by the trim portion, and the glass run can be held in the door frame. Further, the glass run portion and the trim portion are firmly integrally formed, so that the glass run portion can be held by the trim portion.

The vehicle interior hinge portion is formed at the connection portion between the vehicle interior side wall and the glass run portion bottom wall, and the vehicle interior side wall is formed to be pivotable around the vehicle interior hinge portion. Therefore, when the glass run is attached to the door frame, the trim portion is attached to the door panel outer peripheral side flange portion, and then, the vehicle interior side wall is pivoted. In this manner, the glass run portion can be easily attached to the door panel inner peripheral side flange portion.

The vehicle interior side wall retaining lip extending from the vehicle inside to the vehicle outside and in the inner peripheral direction and abutting against the door panel inner peripheral side flange portion is formed at the tip of the vehicle interior side wall, and the vehicle interior side wall retaining lip is formed so that the biasing force on the door panel inner peripheral side flange portion increases when the vehicle interior side wall is pivoted toward the vehicle outside.

Therefore, when the glass run portion is attached to the door panel inner peripheral side flange portion, the vehicle interior side wall retaining lip slides on the surface of the door panel inner peripheral side flange portion. In this manner, the glass run portion can be easily attached to the door panel inner peripheral side flange portion with less friction. When the vehicle interior side wall of the glass run portion is pulled to the vehicle outside from the door panel inner peripheral side flange portion and moved in the direction away therefrom, the root portion of the vehicle interior side wall retaining lip approaches the surface of the door panel inner peripheral side flange portion by the pivotal locus thereof, and the biasing force of the vehicle interior side wall retaining lip on the door panel inner peripheral side flange portion increases. In this manner, the vehicle interior side wall retaining lip can prevent the detachment of the glass run portion.

The vehicle interior hinge portion may be formed on the vehicle outside than the vehicle interior side wall.

In this aspect of the invention, the vehicle interior hinge portion is formed on the vehicle outside than the vehicle interior side wall. Therefore, when the vehicle interior side wall of the glass run portion is pulled to the vehicle outside from the door panel inner peripheral side flange portion and moved in the direction away therefrom, a gap between the vehicle interior side wall retaining lip and the door panel inner peripheral side flange portion becomes narrower, and the biasing force further increases. In this manner, the vehicle interior side wall retaining lip can prevent the detachment of the glass run portion.

A vehicle interior side wall protuberance bulging toward the vehicle inside may be formed at the tip of the vehicle interior side wall, and the vehicle interior side wall retaining lip may be formed from a tip of the vehicle interior side wall protuberance.

In this aspect of the invention, the vehicle interior side wall protuberance bulging toward the vehicle inside is formed at the tip of the vehicle interior side wall, and the vehicle interior side wall retaining lip is formed from the tip of the vehicle interior side wall protuberance. Therefore, when the vehicle interior side wall is pivoted, the vehicle interior side wall protuberance can maintain the gap between the door panel inner peripheral side flange abutting surface and the vehicle interior side wall against the biasing force of the vehicle interior side wall retaining lip. Since the gap is maintained against the biasing force of the vehicle interior side wall retaining lip formed at the tip of the vehicle interior side wall protuberance, the inversion of the vehicle interior side wall retaining lip is prevented and the detachment of the glass run portion can be more reliably prevented.

Further, the vehicle interior side wall retaining lip can be positioned on the vehicle inside than the vehicle interior hinge portion. When the vehicle interior side wall is pivoted, the gap between the vehicle interior side wall retaining lip and the door panel inner peripheral side flange portion becomes narrower and the biasing force on the door panel inner peripheral side flange portion further increases. In this manner, the vehicle interior side wall retaining lip can prevent the detachment of the glass run portion.

A vehicle interior side wall ridge protruding to the vehicle inside may be formed at an intermediate portion of the vehicle interior side wall, and, when the glass run is attached to the door frame, the vehicle interior side wall ridge may abut against the door frame, and a gap may be provided between the door frame and the vehicle interior side wall protuberance.

In this aspect of the invention, the vehicle interior side wall ridge protruding to the vehicle inside is formed at the intermediate portion of the vehicle interior side wall, and, when the glass run is attached to the door frame, the vehicle interior side wall ridge abuts against the door frame, and the gap is provided between the door frame and the vehicle interior side wall protuberance. Therefore, when the glass run is attached to the door frame, the portion of the vehicle interior side wall protuberance can be further inserted to the vehicle inside by the gap and the vehicle interior side wall retaining lip can be prevented from being detached from the door panel inner peripheral side flange portion.

The trim portion may be made of a first material, the vehicle exterior side wall and the glass run portion bottom wall of the glass run portion may be formed of a first material, the vehicle interior side wall, the vehicle interior side wall retaining lip, the vehicle exterior seal lip and the vehicle interior seal lip of the glass run portion may be formed of a second material, and the first material may be harder than the second material.

In the this aspect of the invention, the trim portion is formed of a hard material. Therefore, it is not necessary to form a channel in order to hold the glass run portion in the door frame. When the trim portion formed of a hard material is attached to the door frame flange portion, the trim portion is firmly held by the door frame flange portion, the glass run portion can be attached to the door frame, and the attachment of the glass run is easy.

The vehicle exterior side wall and the glass run portion bottom wall of the glass run portion are formed of a hard material, and the vehicle interior side wall, the vehicle interior side wall retaining lip, the vehicle exterior seal lip and the vehicle interior seal lip of the glass run portion are formed of a soft material. Therefore, the vehicle exterior side wall and the glass run portion bottom wall can prevent the tip of the door glass from being pulled out to the vehicle outside. Furthermore, the vehicle interior side wall retaining lip is brought into close contact with the door panel inner peripheral side flange portion to prevent the detachment of the vehicle interior side wall. Since the vehicle exterior seal lip and the vehicle interior seal lip are soft members, these seal lips are compliantly abutted against the side surface of the door glass to seal the side surface of the door glass.

The vehicle interior side wall retaining lip is formed at the tip of the vehicle interior side wall, and the vehicle interior side wall retaining lip is formed so that its biasing force on the door panel inner peripheral side flange portion increases when the vehicle interior side wall is pivoted toward the vehicle outside. Therefore, when the vehicle interior side wall retaining lip moves in a direction in which the vehicle interior side wall of the glass run portion is detached, the friction between the vehicle interior side wall retaining lip and the door panel inner peripheral side flange portion increases, and the vehicle interior side wall retaining lip can prevent the detachment of the glass run portion. Further, when assembled, the vehicle interior side wall retaining lip slides on the surface of the door panel inner peripheral side flange portion and can be easily attached with less friction.

What is claimed is:

1. A glass run attached to a door frame and adapted to seal a space between the door frame and a door glass, wherein
the door frame includes a door panel outer peripheral side flange portion and a door panel inner peripheral side flange portion which are formed at a tip of the door frame and to which the glass run is attached,
the glass run includes a trim portion attached to the door panel outer peripheral side flange portion, and a glass run portion formed integrally with the trim portion and attached to the door panel inner peripheral side flange portion, the glass run portion configured to seal a space between the door glass and the door panel inner peripheral side flange portion,
the glass run portion has a substantially U-shaped cross-section formed by a vehicle exterior side wall, a vehicle interior side wall and a glass run portion bottom wall, and a vehicle exterior seal lip and a vehicle interior seal lip respectively extend obliquely toward an inside of the substantially U-shaped cross-section from tips of the vehicle exterior side wall and the vehicle interior side wall,
the trim portion has a substantially U-shaped cross-section formed by a glass run-side side wall, a body-side side wall and a trim portion bottom wall, and the glass run-side side wall and the glass run portion bottom wall of the glass run portion are integrally formed or are formed as a same member,
a vehicle interior hinge portion is formed at a connection portion between the vehicle interior side wall and the glass run portion bottom wall, and the vehicle interior side wall is formed to be pivotable around the vehicle interior hinge portion, and
a vehicle interior side wall retaining lip extending from a vehicle inside to a vehicle outside and in an inner peripheral direction and abutting against the door panel inner peripheral side flange portion is formed at a tip of the vehicle interior side wall, and the vehicle interior side wall retaining lip is formed so that a biasing force on the door panel inner peripheral side flange portion increases when the vehicle interior side wall is pivoted toward the vehicle outside.

2. The glass run according to claim 1, wherein
the vehicle interior hinge portion is formed on the vehicle outside than the vehicle interior side wall.

3. The glass run according to claim 1, wherein
a vehicle interior side wall protuberance bulging toward the vehicle inside is formed at the tip of the vehicle interior side wall, and the vehicle interior side wall retaining lip is formed from a tip of the vehicle interior side wall protuberance.

4. The glass run according to claim 3, wherein
a vehicle interior side wall ridge protruding to the vehicle inside is formed at an intermediate portion of the vehicle interior side wall, and
when the glass run is attached to the door frame, the vehicle interior side wall ridge abuts against the door frame, and a gap is provided between the door frame and the vehicle interior side wall protuberance.

5. The glass run according to claim 1, wherein
the trim portion is made of a first material, the vehicle exterior side wall and the glass run portion bottom wall of the glass run portion are formed of a first material, the vehicle interior side wall, the vehicle interior side wall retaining lip, the vehicle exterior seal lip and the vehicle interior seal lip of the glass run portion are formed of a second material, and the first material is harder than the second material.
